(19) United States
(12) Patent Application Publication
(10) Pub. No.: US 2005/0005660 A1
(43) Pub. Date: Jan. 13, 2005

(54) Liquid fertilizer incorporating biosolids and high concentrations of ammonium

(76) Inventors: Jeffrey C. Burnham, Naples, FL (US); Gary L. Dahms, Soda Springs, ID (US)

Correspondence Address: MORRISON & FOERSTER LLP, 1650 TYSONS BOULEVARD, SUITE 300, MCLEAN, VA, 22102, US

(21) Appl. No.: 10/854,751

(22) Filed: May 27, 2004

Related U.S. Application Data
(60) Provisional application No. 60/473,198, filed on May 27, 2003.
(60) Provisional application No. 60/473,197, filed on May 27, 2003.
(60) Provisional application No. 60/479,724, filed on Jun. 20, 2003.

(51) Int. Cl. C05F 1/00

(52) U.S. Cl. 71/11

(57) ABSTRACT

This invention is directed to a method of manufacturing a liquid agricultural fertilizer utilizing biosolids and high concentrations of nitrogen and other essential plant nutrients and the resulting products.

### REFERENCE TO RELATED APPLICATIONS

This application claims priority to U.S. Provisional Application No. 60/473,198 entitled “Liquid Fertilizer Incorporating Biosolids and High Concentrations of Ammonia,” and U.S. Provisional Application No. 60/473,197 entitled “Organic Recycling with Metal Addition,” the entirety of which are both hereby incorporated by reference.

### BACKGROUND

1. Field of the Invention

This invention is directed to a method of manufacturing a liquid agricultural fertilizer utilizing biosolids and high concentrations of nitrogen and other essential plant nutrients and the resulting products.

2. Description of the Background

Methods for the treatment of wastewater sludge to produce a high-nitrogen, i.e., greater than 7% nitrogen by weight on a dry solids basis, liquid fertilizer that is stabilized, microbiologically and chemically safe and so that there are no significant emissions of nitrogen during manufacture or usage. Safe beneficial use methodologies for conversion of sludge to value-added fertilizers are needed in order to deal with the large amounts of wastewater sludge being produced by municipalities and industries.

The state of the art of municipal wastewater sludge processing for the manufacture of beneficial use value-added products that can be used in agriculture follows the paradigm of increasing the dryness or percent solids of a sludge-containing material. This results in the production of soil-like products, organic ag-limes, dried pelletized or granular products or in the example of U.S. Pat. Nos. 5,984,992 and 6,159,263, a high nitrogen and sulfur and/or phosphate-containing granular fertilizer. These basically dry (greater than 50% solids) products are not fluid, will not pass an ASTM standard paint filter test and may be manufactured either to a Class B or Class A standard as per 40 C.F.R. §503, the USEPA rule for biosolids-containing products. These products can not be utilized in conventional liquid field and crop irrigation systems that are commonly employed in commercial farming.

Common practices of manufacturing a liquid sludge of from 1% to 15% biosolids at a municipal wastewater treatment plant that is simply squirted or applied onto agricultural land as a Class B land application methodology. While these sludges do contain some nitrogen, phosphorus and organic materials, they are not value-added products and those municipalities or companies practicing this methodology are under continued social and political pressures to convert their sludge processing to safer and less odorous practices.

### SUMMARY OF THE INVENTION

The present invention overcomes the problems and disadvantages associated with current strategies and designs and provides new tools and methods for creating a stable, microbial pathogen safe, odor-acceptable or odorless liquid fertilizer product that combines municipal waste water sludge or manure with high-value nitrogen and other nutrients so that the mixture can be beneficially used in gardening or commercial agriculture.

One embodiment of the invention is directed to a method for treating organic material such as, preferably, wastewater sludge cakeor or biosolids, so that it is converted into a liquid fertilizer with high nitrogen content. Preferably the nitrogen content is greater than 7% of the dry solids weight of the product. Also preferably the product is stabilized, microbiologically and chemically safe so that there is little to no significant emissions of nitrogen during manufacture or usage of the product. Stabilized means that this product may be stored indefinitely and that there is little to no significant microbial regrowth during storage of this nutrient rich liquid fertilizer mixture. Preferably the count of viable fecal coliform bacteria is under 1000 MPN/gram dry weight of product.

Another embodiment of the invention is directed to producing a flowing liquid fertilizer, which could be easily and economically transported to farm locations where it could be added to commercial irrigation equipment to deliver the incorporated nutrients directly to the soil and/or crops through standard liquid irrigation methods.

Another embodiment of the invention is directed to adjusting the pH of the liquid fertilizer such that the pH can be advantageous to the soil conditioning or to the soil management program of the farmer. This would be particularly advantageous in the growing of crops in overly acid soils or alternatively, in overly alkaline or calcitic soils or in the growing of crops that require special pH management for optimum production.

Another embodiment of the invention is directed to a sludge stabilization process such that the sludge can be sterilized and chemically incorporated with nitrogen compounds, such as preferably ammonium sulfate, mono- and di-ammonium phosphate and ammonium nitrate and urea. This organic and inorganic chemical mixture would be maintained in a flowing liquid state such that it could be easily and economically transported to farm locations where it could be added to commercial irrigation equipment to deliver the incorporated nutrients directly to the soil and/or crop by liquid irrigation methods. One of the advantages of this chemical incorporation is that because of the reactions that occur during manufacture the product is safe with regard to pathogens, i.e., achieves either the USEPA's 40CFR Part 503 Class A (preferably) or Class B standards for biosolids-containing products. A further advantage of this embodiment is that because of the reactions that occur during manufacture the product contains hydrolyzed organic compounds that result from the breakdown of organics originally contained in the sludge component. These smaller organic components can then be more readily utilized by soil microbes or plants for increased productivity and/or they can be formed into complexes with the inorganic salts present in the fertilizer such that the salt anions, such as, sulfate or phosphate and cations, such as, ammonium, such that these nutrients are resistant to volatilization and show slow diffusion of the nutrient into the soil permitting more efficient nutrient uptake by crops.

Another embodiment of the invention is directed to sludge stabilization processes wherein sludge is sterilized and incorporated by blending with nitrogen fertilizer compounds, such as preferably ammonium sulfate, mono- and di-ammonium phosphate and ammonium nitrate and urea. This organic and inorganic chemical mixture is maintained in a flowing liquid state such that it could be easily and economically transported to farm locations where it could be added to commercial irrigation equipment to deliver the incorporated nutrients directly to the soil and/or crop by liquid irrigation methods.

Another embodiment of the invention is directed to liquid fertilizers prepared according to the invention, which can be utilized, for example, in hydroponic farming environments.

Other embodiments and advantages of the invention are set forth in part in the description, which follows, and in part, may be obvious from this description, or may be learned from the practice of the invention.

### DESCRIPTION OF THE FIGURE

FIG. 1 Flow diagram of a preferred method according to the invention.

### DESCRIPTION OF THE INVENTION

As embodied and broadly described herein, the present invention is directed to a method of manufacturing a stable, microbial pathogen safe, liquid fertilizer product that combines biosolids such as, preferably, municipal wastewater, sludges or manures, with high value nitrogen and other nutrients so that the mixture can be beneficially used in gardening or commercial agriculture.

According to the present invention, a method is provided for treating organic materials such as, preferably wastewater sludge cake or biosolid so that it is converted into a high-nitrogen liquid fertilizer that is stabilized, microbiologically and chemically safe and so that there are little to no significant emissions of nitrogen during manufacture or usage. Stabilized means that the product may be stored indefinitely or that there is little to no significant microbial regrowth during storage of this nutrient rich liquid fertilizer mixture. Preferably the count of fecal coliforms should remain under 1000 MPN/gram dry weight of product.

Biosolids that can be processed according to the invention include any and all organic waste materials. This includes, but is not limited to, municipal dewatered sludge. Either raw primary, waste-activated, anaerobic digested or aerobic digested, sludges resulting from the production of antimicrobials and other pharmaceutical products; bacterial fermentation sludges; sludges resulting from the production of beer and wine; mushroom compost waste; paper mill sludges; organic sludges that are in the majority degradable by microorganisms but that are not of biological or microbiological origin; sludges produced from foodstuff production, e.g., grain products; sludges that contain microorganisms from recycled organic products such as paper products; sludges produced by microorganisms during production of chemicals; industrial sludges; other byproducts of microbial activity, particularly related to foodstuff production; and sludges from animal production—particularly produced from animal organic wastes that have been digested or otherwise broken down by microorganisms.

By treating biosolids according to the invention, a desired product is produced that:

utilizes biosolids which may be one of municipal wastewater liquid sludges and dewatered sludge cakes, manures, pharmaceutical wastes, industrial microbial wastes or any microbially-digested food or bio-waste products, or organic extractions of municipal solid waste, or liquid extractions from any of the above;

is treated under combinations of temperature, pressure, ammonia exposure and acidic conditions to kill any pathogens that may be present as a result of incorporation of biosolids in the reaction and/or mixture;

is safe with regard to pathogens, i.e., achieves either the USEPA's 40CFR Part 503 Class A (preferably) or Class B standards for biosolids-containing products;

that can contain between 7 and 22 percent by weight, on a dry weight basis, inorganic nitrogen but preferably contains 14 or higher percent nitrogen by weight on a dry solids basis, or more preferably 1 percent nitrogen by weight on a dry solids basis;

that contain between 7 and 24 percent by weight on a dry solids basis inorganic sulfur or inorganic phosphorus, but preferably contains 14 or higher percent sulfur or phosphorus by weight on a dry solids basis;

that may result in a fertilizer that contain a mixture of inorganic nutrient anions such as a mixture of phosphate and sulfate resulting from the incorporation of both sulfuric acid and phosphoric acid in the exothermic reaction with liquid or gaseous anhydrous ammonia;

is initially treated under acidic conditions to minimize and prevent the emission of nitrogen-containing compounds during and after sludge processing;

utilizes concentrated inorganic acids and liquid or gaseous anhydrous ammonia to supply the major sources of the inorganic nutrients as well as the heat of reaction that is responsible for microbial reduction;

that can utilize the pipe-cross or tubular reactor mechanism to react concentrated inorganic acids and liquid or gaseous anhydrous ammonia to form an ammonium salt cooled by injection of liquefied biosolids;

contains an organic fraction that complexes with the inorganic nutrients in the mixture;

that results in a complex formed of organic molecules bound to the ammonium salt molecules;

minimizes the opportunity for microbial regrowth and potential microbial fouling of the liquid mixture;

is in its concentrated form greater than 5% suspended and soluble solids, preferably greater than 10% suspended and soluble solids, and more preferably greater than 20% suspended and soluble solids (80% or less water);

that is safe for public or commercial agricultural usage as defined by the 40 CFR Part 503 Class A or Class B rules for biosolids-containing products;

that will benefit the soil to which the liquid fertilizer is added in that the pH of the soil can be adjusted and/or controlled and such that the organically-enhanced inorganic nitrogen fertilizer can enhance soil microbes and/or enhance the nutrient uptake by the target plant root structure to permit and enhance the production of crops;

can be marketed as a commodity liquid agricultural fertilizer for its N, P, S value; and

in its finished product is in the form of a liquid mixture that may be used directly or diluted into farm irrigation systems for application.

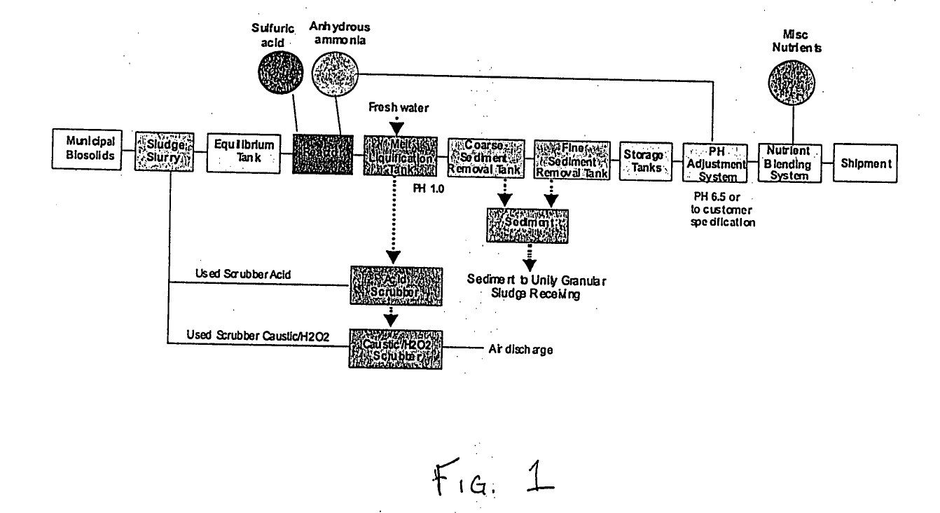

The method according to a preferred embodiment is shown in FIG. 1. The method of FIG. 1 is explained in part in U.S. Pat. No. 6,406,510, which disclosure is incorporated herein by reference.

The mixture used in the method of FIG. 1 may contain emulsifiers and or chemical agents designed to help maintain the mixture in a suspension.

Adding nutrients is typically integral to the stabilization of the municipal biosolids and may involve the use of a cross-pipe or tubular reactor or other vessel designed for the creation of ammonium salts using liquid or gaseous anhydrous ammonia and concentrated acids. Osmolarity created by the concentration of inorganic salts mixed with the solids from the biosolids material that prevents any microbial contamination or regrowth from becoming significant as defined by the creation of an odorous septic nuisance.

The addition of ferric compounds selected from the group consisting of ferric oxide, ferric phosphate, ferric sulfate or ferric carbonate, can facilitate the solubilization of the mixture, as well as assist in the reduction of any odors that might result from the incorporation of the organic biosolids into the reaction. Organic-iron complexes that result also serve to facilitate the usefulness of the iron as a micronutrient in the nutrition of the target crops. The method of the present invention can also be performed so that its product will meet either the USEPA 40 C.F.R. §503 Class A or Class B pathogen standards. The Class A standard can be achieved using Alternative 1, the time and temperature rule, of this pathogen standard. Alternative 1 for achieving the Class A product designation may be provided as a result of the exothermic reaction of concentrated acids with liquid or gaseous anhydrous ammonia. These exothermic reactions can be achieved using concentrated acids selected from the group consisting of sulfuric, sulfamic, phosphoric, hydrochloric or nitric acids. This chemical reaction causes the mixture to achieve the time/temperature requirements published by the USEPA in USEPA 40 C.F.R. §503 so that the pathogen kill component of the §503 rule is met.

Other embodiments and uses of the invention will be apparent to those skilled in the art from consideration of the specification and practice of the invention disclosed herein. All references cited herein including U.S. Provisional Application No. 60/473,197 and the corresponding non-provisional application filed contemporaneously herewith, U.S. patent application Ser. Nos. 08/852,663, 09/735,768 and 09/416,370, all written publications, all U.S. and foreign patents and patent applications, and all published statutes and standards, are specifically and entirely incorporated by reference. It is intended that the specification and examples be considered exemplary only with the true scope and spirit of the invention indicated by the following claims.

1. A method comprising converting an organic material into a liquid fertilizer which is initially sterile and has a predetermined nitrogen content.

2. The method of claim 1, further comprising a pipe-cross or tubular reactor mechanism to react concentrated inorganic acids and liquid or gaseous anhydrous ammonia to form an ammonium salt cooled by injection.

3. The method of claim 1, further comprising predetermining a pH or pH range of the liquid fertilizer.

4. The method of claim 1, wherein the liquid fertilizer contains greater than 5% suspended and soluble solids in a concentrated form.

5. The method of claim 1, wherein the liquid fertilizer contains greater than 10% suspended and soluble solids in a concentrated form.

6. The method of claim 1, wherein the liquid fertilizer contains greater than 20% suspended and soluble solids in a concentrated form.

7. The method of claim 1, further comprising adding a concentrated acid such that the nitrogen content of the liquid fertilizer is greater than 7% by weight on a dry solids basis.

8. The method of claim 1, further comprising adding a concentrated acid such that the nitrogen content of the liquid fertilizer is greater than 12% by weight on a dry solids basis.

9. The method of claim 1, further comprising adding a concentrated acid such that the nitrogen content of the liquid fertilizer is greater than 17% by weight on a dry solids basis.

10. The method of claim 1, further comprising adding a concentrated acid such that the sulfur or phosphorus content of the liquid fertilizer is greater than 7% by weight on a dry solids basis.

11. The method of claim 1, further comprising adding a concentrated acid such that the sulfur or phosphorus content of the liquid fertilizer is greater than 12% by weight on a dry solids basis.

12. The method of claim 1, wherein the organic material comprises biosolids or sludge.

13. The method of claim 1, wherein the organic material is selected from the group consisting of municipal dewatered sludge, raw primary sludge, waste-activated sludge, anaerobic digested or aerobic digested sludge; sludges resulting from production of antimicrobials and pharmaceutical products; bacterial fermentation sludges; sludges resulting from production of beer or wine; mushroom compost waste; paper mill sludges; organic sludges that are degradable by microorganisms but are not of biological or microbiological origin; sludges produced from foodstuff production, grain products; sludges that contain microorganisms from recycled organic products; sludges produced by microorganisms during production of chemicals; industrial sludges; byproducts of microbial activity, byproducts of foodstuff production; sludges from animal production, sludges produced from animal organic wastes digested or otherwise broken down by microorganisms, and combinations thereof.

14. The method of claim 1, which meets or exceeds USEPA Class A microbiological standards for pathogens.

15. A liquid fertilizer made by the method of claim 1.

16. A method comprising:
creating a sludge slurry from an organic material;
incorporating nitrogen compounds into the sludge slurry; and
sterilizing the sludge slurry while maintaining a liquid state.

17. The method of claim 16, wherein the organic material comprises dewatered wastewater sludge cake.

18. The method of claim 16, wherein the sterilized sludge slurry is converted into a high-nitrogen liquid fertilizer that is stabilized, and microbiologically and chemically safe for application to crops.

19. The method of claim 16, which produces no significant emissions of nitrogen in the form of ammonia or nitrogen oxides.

20. The method of claim 16, further comprising producing a liquid fertilizer from the sterilized sludge slurry that is stabilized.

21. The method of claim 16, further comprising initially treating the organic material under acidic conditions to minimize emission of nitrogen-containing compounds during operation.

22. The method of claim 16, further comprising adding concentrated inorganic acid and liquid or gaseous anhydrous ammonia.

23. The method of claim 22, wherein adding concentrated inorganic acid and liquid or gaseous anhydrous ammonia produces heat that at least partly reduces microbial organisms and maintains said liquid state.

24. The method of claim 22, wherein the concentrated inorganic acid and liquid or gaseous anhydrous ammonia causes organic compounds to react with inorganic anions and cations forming complexes.

25. The method of claim 24, wherein the complexes reduce volatilization of nitrogen.

26. The method of claim 24, wherein the complexes are capable of diffusing into soil.

27. The method of claim 22, wherein a combination of temperature, pressure, ammonia exposure and acidic conditions of the method kill pathogens present in the organic material.

28. The method of claim 22, wherein a combination of heat, pressure, and pH created by reaction of concentrated acid and anhydrous ammonia in a pipe-cross or tubular reactor produces hydrolysis of organic molecules present in the organic material.

29. The method of claim 16, further comprising adding emulsifiers or chemical agents to maintain a suspension.

30. A fertilizer product produced by the method of claim 16.

31. The product of claim 30, which can be stored indefinitely.

32. The product of claim 30, wherein there is no significant microbial pathogen regrowth during storage.

33. The product of claim 30, which has a count of viable fecal coliforn bacteria under 1000 MPN/gram dry weight of product.

34. The product of claim 30, which is sterile and chemically incorporated with nitrogen compounds.

35. The product of claim 34, wherein the nitrogen compounds comprise ammonium sulfate, mono- or di-ammonium phosphate, ammonium nitrate, urea or a combination thereof.

36. A method for incorporating nutrients into soil comprising applying the product of claim 30 to said soil.
